(19) United States
(12) Patent Application Publication
(10) Pub. No.: US 2012/0219940 A1
(43) Pub. Date: Aug. 30, 2012

(54) ABALONE SPERM PRESERVATION METHOD FOR THE AQUACULTURE INDUSTRY

(75) Inventors: Enrique Marcelo Dupré Moragas, San Joaquin (CL); Merari Simei Goldstein Vasquez, Coquimbo (CL); Herman Christian Rojas Andrade, Coquimbo (CL)

(73) Assignee: UNIVERSIDAD CATOLICA DEL NORTE, Antofagasta (CL)

(21) Appl. No.: 13/393,733

(22) PCT Filed: Aug. 30, 2010
(86) PCT No.: PCT/IB2010/053887

§ 371 Date: May 14, 2012

(30) Foreign Application Priority Data
Sep. 4, 2009 (CL) 1814-2009

(51) Int. Cl. A01N 1/02

(52) U.S. Cl. 435/2

(57) ABSTRACT

The invention relates to a method for the preservation of sperm from abalone, in particular green abalone, Haliotis discus hannai and red abalone, H. rufescens: consisting in mixing the sperm with cryoprotectant containing propylene glycol, sucrose and egg yolk; freezing the sperm with cryoprotectant down to a temperature of approximately −40° C.; and storing same in liquid nitrogen. The method also includes the thawing of the sperm samples.

The invention relates to a method for the cryopreservation of sperm from abalones, in particular green abalone, Haliotis discus hannai and red abalone, H. rufescens. The invention aims to optimize and innovate in alternative technologies by using genetically improved material. The method of the invention is in particular directed to the sperm cryopreservation of abalones with highly valuable characteristics (HVC) for commercial farming.

The technique permits long-term cryopreservation of sperm carrying genes that express certain characteristics, such as, growing rates, coloring, etc. In HVC abalone sperm can be selected as mayor characteristics motility, survival, and fertilization rate, which guarantee successful batches.

On one hand, cryopreservation protocols include selecting the cryoprotectants and cryopreservants, their concentration, optimal temperatures of transition, freezing and thawing times.

The technology allows preserving sperm dosage for fertilization at any time that is required, especially when the number of specimens for breeding is limited because not all induced to spawn respond. The method of the present invention facilitates the work in the larvae culture in hatcheries, through separating the production from the natural breeding cycle of males.

### PREVIOUS ART

There are more than 200 studies in cryopreservation of fish sperm. The most important are summarized in the study of Rana, K., 1995, “Cryopreservation of fish sperm”, in: Methods in molecular biology: Cryopreservation and freeze-drying protocols. Eds. Day J. G., M. R and McLellan. Vol. 38, pp 151-165.

About 30 studies have been published in cryopreservation of marine invertebrate sperm, between them we will cite the followings, which specifically relate to abalones.
Gwo, J., Chen C. & Cheng H., 2002. “Semen cryopreservation of small abalone (Haliotis diversicolor supertexa)”. Theriogenology, 58: 1563-1578.
Salinas L., C. Paniagua, Jenkins A., Tiersch T., 2005. “Cryopreservation of sperm of red abalone”. Journal of Shellfisheries Research 24(2): 415-420

The work of Salinas et al. (2005) is the only one that relates to one of the species considered in this patent (red abalone). From both studies mentioned above none of them has escalated to a productive level, being the results applied only to small scale. This is the great importance, since the development of a cryopreservation method for productive scale requires further investigation and development of the laboratory stage results; in general, several steps of the method developed at laboratory level require non-trivial adjustment to be applicable to industrial level. In addition, Salinas et al. (2005) evaluate the properties of the following cryoprotectants: dimethyl sulfoxide (DMSO), propylene glycol (PG), and glycerol without any additives (such as egg yolk). The only coincidence from said study with the present invention relies in the use of propylene glycol cryoprotectant, however, the concentration used in cryoprotectans do not correspond with the present invention. The freezing program disclosed from Salinas et al. (2005), is not similar to the program described herein.

The following studies conducted in oysters and scallops; establish sperm motility without distinguishing whether this movement is slow or fast, or its speed. None of them builds the adequacy of the cryoprotectant concentration and equilibration time in spermatic parameters before and after freezing-thawing process, such as moving distance and speed of movement, as does the present invention.
Faure C., Devauchelle N. & Girard J., 1994. <<Ionic factors affecting motility, respiration and fertilization rate of the sperm of the bivalve Pecten maximus (L.)”. J. Comp. Physiol., 164: 444-450.
Dong Q., Eudeline B., Allen Jr. S. K. & Tiersch T. R., 2002. “Factors affecting sperm motility of tetraploid Pacific oysters”, J. Shellfish Res., 21: 719-723.
Dong Q., Eudeline B., Huang C., Tiersch T. R., 2005b. “Standardization of photometric measurement of sperm concentration from diploid and tetraploid Pacific oysters, Crassostrea gigas (Thunberg)”, Aquaculture. Research, 36: 86-93.

The most commonly used method for measuring motility, is direct visual assessment under microscope in a Nebauer chamber.
Dong, Q., Huang Ch., Eudeline B., & Tiersch T., 2005c. “Systematic factor optimization for cryopreservation of shipped sperm samples of diploid pacific oyster Crassostrea gigas”. Cryobiology, 51, 176-197.

There are three patents related to the invention, U.S. Pat. No. 6,054,317, GB N^{o} WO9806255, and GB N^{o} WO9101636. None of these patents is related to abalones of the species that study comprises.

The summary titled “Protocols for haliotis rufescens egg cryopreservation and in vitro fertilization, year 2”, for the second year student project under the program of the “California State Science Fair”, published on 2007, describes the red abalone egg cryopreservation with a cryoprotectant containing only PG, in comparison with another cryoprotectant containing only DMSO. The results shown are quiet limited regarding the period of study and operating conditions. Therefore, they are not equivalent to the present invention, in addition to being directed to the preservation of oocytes.

Besides, the patent application WO2007146344A, applied in 2007, disclose a composition for sperm cryogenic preservation, that comprises at least a cryoprotectant, selected from a group consisting of sugar, raffinose, lactose, trehalose, melibiose, melezitose, mannotriose, stachiyose, dextran, hydroxy-ethyl starch, sucrose, maltitol, lactitol, glycerol, polyalcohols and others selected from a group consisting of polyethylene glycol, DMSO, ethylene glycol, propylene glycol, polivynyl pyrrolidone, glycerol and polyethylene oxide; at least one membrane protectant (egg yolk protein) and at least one free radical scavenger (reducing agent); that does not combine the cryoprotectant agents in the same way as does the present invention; and wherein the combination of the present invention has proven to be superior to what is described in the examples of the patent application WO2007146344A.

The above mentioned patent indicates, that only enables a better survival of cryopreserved mammal sperm (especially rodents and bovine sperm), even when it can be used on others animal like cat, horses, birds and aquarium fishes; but there is no case where it is used in invertebrates and less in marine invertebrates, as it is proposed in the present invention. The rates obtained in vertebrates, according to the above mentioned patent, are higher than the reported in the present invention; however, the plasma membrane composition of marine invertebrates is different of those of vertebrates. Therefore, the motility and fertilization rates obtained with both types of cryopreserved sperm are not comparable.

The abalone production largely depends on the genetic material of the parents. The abalone breeding is difficult and requires, when done with natural methods, synchronization of males and females to achieve successful fertilization.

The quality of the specimens obtained by the synchronization of the parents, is not always homogeneous, thus, the quality of these abalones will have great variability, getting even to obtain products that does not meet the required standards in the different markets.

To have a selected sperm stock from parents with desirable characteristics allowed the independence of the fertilization process from the synchronization of parents.

Besides from allowing the independence from the synchronization of parents, cryopreservation allowed selecting biological material of species with desirable characteristic for production, such as larger size, better color, etc.; that is, highly valuable characteristics (HVC).

The method of the present invention solves the technical problem regarding the synchronicity of male and female abalones, while providing a biological material stock from specimens with highly valuable characteristics; in order to guarantee quality and homogeneous production.

Especially, the method of the present invention provides means for preserving abalones sperm, more preferably from two species of abalones; red abalone and green abalone, for industrial-scale fertilization. The method of the invention has optimized the different process steps.

The method comprises 6 major steps, described below.
(a) Providing sperm to preserve: the abalone gametes can be obtain for any method known in the art, in particular, the preferred method of the present invention is by spawning induction in the specimens with hydrogen peroxide (H₂O₂) and 2M Tris, or by spawning induction under conditions of darkness and desiccation; in particular, the spawning method with 2M Tris and H₂O₂ is well known in the art (“Hydrogen peroxide induces spawning in mollusks, with activation of prostaglandin endoperoxide synthetase” Morse D. E., Duncan H., Hooker N., and Morse A. Science, Apr. 15, 1977; 196: 298-300). Once obtained the sperm by any method known in the art, sperm counting is performed by a method of image analysis and obtaining at least two motility parameters, in order to keep a quality control.
(b) Providing an adequate cryoprotectant solution, in particular, containing propylene glycol at a concentration between 3 to 7 M, sucrose from 3 and 6% (volume/volume), and egg yolk between 8 and 12% (volume/volume);
(c) Adding to a Petri dish a volume of obtained sperm equivalent to the volume of the cryoprotectant solution from the previous step, mixing gently;
(d) Loading in a 0.5 mL straw a volume between 30 and 80 μL of micro-filtered seawater, then a volume between 30 and 80 μL of air, then a volume between 100 and 150 μL of sperm solution from the previous step, later a volume between 30 and 80 μL of air, and finally a volume between 30 and 80 μL of micro-filtered seawater. The straw is sealed using polyvinyl alcohol (PVA). The equilibration time was between 5 and 15 minutes;
(e) Freezing the samples using any technique known in the art, preferably a programmable freezing chamber, at a starting temperature between 5.5° C. and 6.5° C. and lowering the temperature to −5° C. using a freezing rate between −5.5 to −4.5° C./min; further lowering the temperature until between −38 and −42° C. using a freezing rate between −17 to −19° C./min; upon reaching a temperature between −38° C. and −42° C. dipping into liquid nitrogen and stored until use;
(f) Thawing sperm for use by removing the straws from liquid nitrogen, placing them between 1 to 5 seconds at room temperature, dipping immediately into a thermo regulated bath at a temperature between 45 and 55° C. for between 5 to 10 seconds, placing the contents of the straw in an appropriate container and adding between 0.5 and 1.0 mL of micro-filtered seawater to stop the cryoprotectant effect.

In every step of the method involving seawater, must be understood that the seawater has been sterilized using any state of the art method, such as 0.22 μm microfiltration membranes, or later using ultraviolet light.

Abalone hatcheries producers perform fertilizations by using conditioned breeding specimens, which are induced to spawning. The results depend on the reproductive cycle and conditioned breeding specimens.

The advantage of this invention is to have stored sperm, with quality assurance, that allow planned spawning according to the demand, and where the stored sperm are from specimens with highly valuable characteristics.

### APPLICATION EXAMPLES

### Example 1

### Preservation of Abalone Red Sperm, Haliotis Rufescens

(a) Obtaining Sperm

Abalone gametes were obtained by induction of gamete release in mature specimens. The induction was performed with hydrogen peroxide and 2M Tris, as known in the art (“Hydrogen peroxide induces spawning in mollusks, with activation of prostaglandin endoperoxide synthetase” Morse D E, Duncan H, Hooker N, and Morse A. Science Apr. 15, 1977 196: 298-300)

(b) Cryoprotectant Solution and its Concentration

The following cryoprotectant solution was used

Propylene glycol (6M PG), 5% sucrose (w/v), and 10% egg yolk (v/v).

Once prepared, the solution was centrifuged at 1000 rpm for 10 minutes, the supernatant was separated and stored at 6° C. until further use.

(c) Sperm and Cryoprotectant Solution Mixture

In a Petri dish were placed 2 mL of obtained sperm and then added 2 mL of cryoprotectant solution, obtaining a molarities of 3M for each sample. After contacting the sperm and the cryoprotectant in the Petri dish, the straws were filled (0.5 mL), previously labeled according to the cryoprotectant and corresponding molarities. The mixture was let stay for 10 min. (equilibration time) before freezing.

(d) How to Load the Straws with Sperm-Cryoprotectant Solution
The straws were filled with an automatic micropipette according the following procedure:

| | |
|---|---|
| 1° | Suck up seawater (about 0.05 ml) |
| 2° | Suck up the same amount of air (about 0.05 mL) |
| 3° | Suck up the sperm solution (about 0.3 mL) |
| 4° | Repeat step 2 and then step 1 |
| 5° | Finally the straw is sealed with polyvinyl alcohol (PVA) |

(e) sample freezing
Properly labeled straws were placed in a Planner Model Kryo 560-16 cryopreservation chamber. Upon loading the chamber, the appropriate program was run up to −40° C. of temperature. The freezing program used is detailed below:
   1. Starting temperature: 6° C.
   2. From 6° C. to −5° C. at a rate of −5° C./min.
   3. From −5° C. to −40° C. at a rate of −18° C./min.
   4. Straws remain for 5 min under these conditions.
   5. Straws are removed and dipped into liquid nitrogen.
After dipping into liquid nitrogen, we proceed to storage in a MVE model XC 32-8 flask. The samples remained at −196° C. until its thawing.

(f) Thawing
Each straw was thawed placing them 3 sec. at room temperature, then were dipped into a thermoregulated bath at 50° C. for 7 seconds. Later both ends of the straw were cut to release their content, which was placed on a Petri dish, where is added 0.2 mL of microfiltered seawater and was held for 5 minutes to stop the cryoprotector effect and enable the sperm activation.

### Example 2

### Cryopreserved Sperm Fertilization

Before starting the cryopreservation process, the fresh oocytes obtained from spawning were inseminated with fresh sperm for determining the fertilization rate of control. For that, in a beaker there were mixed 50 mL of oocytes with 3 mL of fresh sperm.

To determine the fertilization rates with frozen-thawed sperm, there were used Petri dishes of 3.5 cm of diameter with 2 mL of fresh oocytes, shaking for 2 minutes.

For both control and experimental fertilization, after 15 minutes post-insemination, fertilized oocytes were placed in crystallizers of 95 mm diameter with 100 mL of microfiltered seawater, which was replaced after 15-20 minutes. They were allowed to grow until the veliger larvae state and then it was determined the rate of larvae obtained from cryopreserved sperm.

### Microscope Direct Visual Assessment

Counting was performed in four quadrants diagonally shaped in Nebauer chamber, also checking the sperm motion. The data was recorded and it was change to rates.

### Assessment by Image Analysis

Once the sample was mounted on the microscope, 4 videos of 5 seconds each were recorded, each one corresponding to one evaluation quadrant of the counting protocol of Nebauer chamber, described above.

The videos were taken with a digital camera (Canon PowerShot A620) and saved in digital format for later analysis by image analysis software. With this software was determined the sperm number, movement rate and the distance covered per second.

The above mentioned fertilization was performed, both with fresh sperm as sperm undergone the cryopreservation method and held in storage over a period of 2 to 10 days. The fertilization rate with fresh sperm ranged from 87 and 97%, while the fertilization rate using cryopreserved sperm was 40±7.2%.

By analyzing DNA fragmentation using comet assay, was obtained a 35% of fresh sperm fragmentation and a 36 to 40% for cryopreserved sperm.

### Example 3

### Preservation of Green Abalone Sperm Haliotis Discus Hannai

In the green abalone case were followed the same steps than in Example 1 for red abalone, only changing the concentration of propylene glycol in cryoprotectant solution to a 3M concentration.

The fertilization rate for the green abalone was 24.2±5%.

### Example 4

### Evaluation of Sperm Motility of Abalone Red Gametes, Undergoing the Method of the Present Invention

Samples in triplicate of stored sperm from example 1 and example 3 were assessed for spermatic motility after thawing.

For red abalone was obtained a mean spermatic motility rate of 93±4%, for green abalone 87±6% and the fertilization rates with cryopreserved sperm for red abalone was 40±7.2% and for green abalone was 20.2±5%. These results prove the superiority of the method of the present invention, against previously described methods and cryoprotectants.

1. Method for abalone sperm preservation, comprising the following steps:
a) providing abalone sperm for cryopreservation;
b) providing a cryoprotectant solution comprising propylene glycol, sucrose and egg yolk;
c) adding to a volume of sperm of step (a) the same volume the cryoprotectant solution from the previous step, mixing gently;
d) loading in an appropriate straw a volume between 30 and 80 μL of micro-filtered seawater, then a volume between 30 and 80 μL of air, then a volume between 100 and 150 μL of sperm solution from the previous step, later a volume between 30 and 80 μL of air, and finally a volume between 30 and 80 μL of micro-filtered seawater. The straw is sealed and the equilibration time was between 5 and 15 minutes;
e) freezing the samples at a temperature of −40° C. and storage into liquid nitrogen; and
f) thawing the sperm for their use, removing straws from storage into liquid nitrogen.

2. The method for preservation of claim 1, wherein the cryoprotectant solution comprises propylene glycol between 3 to 7 M, sucrose between 3 and 6% weight/volume, and egg yolk between 8 and 12% volume/volume.

3. The method for preservation of claim 1, wherein for freezing is used a programmable freezing chamber with a starting temperature between 5.5° C. and 6.5° C. and lowering the temperature until between −5.5° C. and 4.5° C. using a freezing rate between −5.5 to −4.5° C./min; further lowering the temperature until between −38 and −42° C. using a freezing rate between −17 to −19° C./min; upon reaching a temperature between −38° C. and −42° C. dipped into liquid nitrogen and storage until use.

4. The method for preservation of claim 1, wherein for thawing, the straw is placed from 1 to 5 seconds at room temperature, dipping immediately into a thermo regulated bath at a temperature between 45 and 55° C. for between 5 to 10 seconds, placing the content of the straw in an appropriate container and adding between 10 and 40 μL of micro-filtered seawater to stop the cryoprotectant effect.

5. The method for preservation of claim 1, wherein the abalone is Haliotis rufescens.

6. The method for preservation of claim 1, wherein the abalone is Haliotis discus hannai.
